(19) United States
(12) Patent Application Publication
(10) Pub. No.: US 2017/0283065 A1
(43) Pub. Date: Oct. 5, 2017

(54) Aircraft Interior Surface and Method of Illuminating an Aircraft Interior Surface

(71) Applicant: B/E Aerospace, Inc., Wellington, FL (US)

(72) Inventors: Robert Papke, Camano Island, WA (US); Shawn Claflin, Seattle, WA (US); Stephanie Lightbody, Snohomish, WA (US); Jefferey McKee, Duvall, WA (US)

(21) Appl. No.: 15/478,568

(22) Filed: Apr. 4, 2017

Related U.S. Application Data
(60) Provisional application No. 62/317,702, filed on Apr. 4, 2016.
(60) Provisional application No. 62/317,701, filed on Apr. 4, 2016.

(51) Int. Cl. B64D 11/06; G02F 1/163; G09F 19/22; E06B 9/24

(52) U.S. Cl. CPC B64D 11/0606; E06B 9/24; G02F 1/163; G09F 19/22; E06B 2009/2417; E06B 2009/2464

(57) ABSTRACT

An aircraft interior surface for partitioning, dividing, or establishing privacy within a cabin space includes a transparent material that provides for transmission of light within the aircraft cabin. A graphical design may be applied to the transparent material, the graphical design including indicia arranged in predetermined patterns based on a location or function of the transparent material. A light source located proximate to the transparent material may wash light across a surface of the transparent material such that the graphical design exhibits predetermined properties when illuminated by the light source. The transparent material may be selectively dimmable to increase opacity.

### RELATED APPLICATIONS

This application claims priority to U.S. Provisional Patent Application Ser. No. 62/317,702, entitled “Aircraft Interior Surface and Method of Creating an Aircraft Interior Surface,” filed Apr. 4, 2016, and to U.S. Provisional Patent Application Ser. No. 62/317,701, entitled “Dimmable Window for Direct View in Aircraft Cabins,” filed Apr. 4, 2016. This application is related to the following prior patents by B/E Aerospace, Inc.: U.S. Pat. No. 9,192,008, entitled “Reduced-Size Modular LED Washlight Component,” filed Mar. 15, 2013 by Eckel et al. and issued on Nov. 17, 2015, directed to a LED washlight component; and U.S. Pat. No. 9,022,320, entitled “Aircraft Passenger Suite with Combination Bed,” filed Mar. 13, 2013 by Wallace et al. and issued on May 5, 2015, directed to an aircraft passenger suite. All above identified applications are hereby incorporated by reference in their entireties.

### BACKGROUND

Some placements of interior aircraft surfaces are restricted by law. For example, the current certification process for commercial aircraft includes a requirement for flight attendants to have a direct view of a certain percentage of seated passengers in the cabin. As used in U.S. statute §25.785(h)(2) [§25.785(h)(1)], “direct view” means direct (line of sight) visual contact with cabin area/main aisle(s), which enables the flight attendant to be made aware of passenger needs relative to safety when the flight attendant is seated with torso restraint (safety belt and shoulder harness) fastened. Mirrors or other such devices are not acceptable equivalents to direct view, except in those cases where flight attendant proximity to the floor level emergency exit takes precedence over direct view.

Additionally, each of the various different surfaces of the aircraft interior may have unique properties based on their function or location within the aircraft such as flame resistance, wear resistance, smoke resistance, and water resistance. In some aircraft, the passenger cabin can be divided with an opaque cabin wall including a fold down flap for making direct eye contact with the passengers. In this typical configuration, a flight attendant is required to manually unlatch and lower the fold down flap into its taxi, take off, and landing (“TTL”) position. After TTL, the flight attendant is then required to return the fold down flap into its closed position.

Aircraft cabin interiors are confined spaces that many passengers may be enclosed within for extended periods of time, particularly during long haul flights that have durations longer than five, eight, ten, or twelve hours. Being in the confined space of the aircraft cabin for long periods of time can cause discomfort to passengers either due to claustrophobia or general physical discomfort from being confined to a single space for a long period of time. In some instances, increasing transmission of light throughout the aircraft cabin can improve the overall passenger experience.

Increasing light transmission throughout an aircraft cabin through the installation of traditional transparent surfaces, however, such as transparent paneling for aircraft suites in premium class aircraft cabins may be problematic due to the potential for passengers' decreased sense of privacy.

In addition, while airline carriers and aircraft manufacturers have widely applied advertising or branding indicia to exterior aircraft surfaces, they have often struggled to find ways to incorporate advertising or branding indicia to interior surfaces of the aircraft cabin.

### SUMMARY OF ILLUSTRATIVE EMBODIMENTS

The forgoing general description of the illustrative implementations and the following detailed description thereof are merely exemplary aspects of the teachings of this disclosure, and are not restrictive.

In certain embodiments, an aircraft interior surface includes a transparent material located within an interior of an aircraft cabin that provides for transmission of light within the aircraft cabin. A graphical design is applied to the transparent material and includes indicia arranged in predetermined patterns based on a location or function of the transparent material. A light source located proximate to the transparent material that washes light across a surface of the transparent material such that the graphical design exhibits predetermined properties when illuminated by the light source.

In certain embodiments, the transparent material is made of glass, plastic, crystal, acrylic, polycarbonate, polystyrene, cellulose, ceramic, lacquer, urethane, epoxy, resin, or combinations thereof The transparent material can make up at least a portion of interior surfaces and panels within an aircraft cabin.

In certain embodiments, the aircraft interior surface includes an associated transparency control system that is configured to deliver an activation power or voltage to an electronic glass technology within the transparent panel, surface, or material. In some implementations, the transparent material may include multiple layers one of which is an electronic glass layer that can adjust an amount of transparency based on an applied voltage. In other implementations, a single layer panel of transparent material may be electronic glass.

In certain embodiments, graphical designs may be applied to the transparent material through various means including printing directly to the transparent panel, applying in sheet form to the transparent panel, or integrating into the transparent surface at the time of manufacture. In some implementations, the integration of the graphical design into the transparent surface may involve etching the graphical design into the transparent parcel and filling in the etched surfaces with desired colors or patterns.

In certain embodiments, the graphical design may be printed directly to the transparent panel or integrated into the transparent surface at the time of manufacture for permanent or non-seasonal graphical designs that are not time-sensitive or may not need to be changed for long periods of time. In some examples, the sheet form of the graphical design may be applied with a semi-permanent or removable adhesive on one side of the sheet that allows the graphical design to be removed from the transparent panel. Semi-permanent or removable graphical designs may be used for temporary and/or seasonal graphical designs that may be changed on a periodic basis.

In certain embodiments, the graphical design may expose portions of the transparent material between indicia of the graphical design. In other implementations, the graphical design may include a background surface on which the indicia are disposed. The background surface and indicia of the graphical design may be applied to the transparent surface as a single layer or multiple lavers. Colors of the indicia of the graphical design may be selected to reflect a color of the light applied to the transparent material by illumination devices directed at the transparent panel.

In certain embodiments, the aircraft interior surface includes an associated illumination system that is configured to direct light onto the transparent panel. The illumination system may include multiple light emitting diode (LED) washlights that are configured to emit light in all colors of the visible light spectrum based on the combination of light emitted from red, green, blue, and white LEDs. In some implementations, the illumination system includes a controller 502 that controls the illumination of the transparent panel as well as other transparent panels within the aircraft cabin based on various criteria that may include received inputs from the passenger or flight attendant at an input/output (I/O) device, a sensed status of the passenger within a suite or seat, sensed characteristics of the light within the aircraft cabin, the type of graphical design displayed on the transparent device, an effect of the illumination output by the illumination on adjacent suites or compartments, or received inputs from a user.

Benefits of the embodiments described herein include increasing an amount of light transmitted throughout the aircraft cabin due to the presence of transparent panels throughout the interior of the aircraft to promote feelings of spaciousness for passengers who may normally feel constricted within the confined space of the aircraft cabin on long haul flights. Feelings of privacy for passengers within the aircraft cabin can also be achieved even with transparent panels throughout the aircraft due to the graphical designs applied to the transparent panels and adjustable amounts of illumination that are directed toward the transparent panels.

Benefits of the embodiments described herein also include providing graphical images that are pleasing for passengers to look at and also having an additional means for promoting brands and/or products through graphical designs that include advertising indicia. In some implementations, transparent panels located within a field of view of a passenger may have graphical designs including advertising indicia in order to maximize an amount of exposure of the passenger to advertisements.

Benefits of the embodiments described herein include providing a dimmable transparent panel for allowing direct viewing of cabin areas and main aisles of commercial aircraft. In some implementations, transparent panels can be located within a cabin partition dividing different cabin areas, where the transparent panel can be configured to change state from an opaque (non-transparent) panel to a clear window, thereby providing visual access when needed.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1A illustrates a perspective view of a generic aircraft interior surface according to an example;

FIG. 1B illustrates a perspective view of a class divider including a transparent panel in an upper region of the class divider according to an example;

FIG. 1C illustrates a perspective view of a center divider including a transparent panel within a central portion of the center divider according to an example;

FIG. 1D illustrates a perspective view of a ceiling mounted class divider including a transparent panel according to an example;

FIG. 1E illustrates a perspective view of cabin wall including a transparent panel according to an example;

FIG. 2A illustrates a side view of an aircraft interior surface;

FIG. 2B illustrates a perspective view of an aircraft interior surface;

FIG. 2C illustrates a perspective view of an aircraft interior surface;

FIG. 2D illustrates a front view of a ceiling mounted class divider including a transparent panel having a transparent material in communication with a transparency control system, where the transparent material is configured to be transparent according to an example;

FIG. 2E illustrates the ceiling mounted class divider of FIG. 2D, where only a portion of the transparent material is configured to be opaque or translucent according to an example;

FIG. 2F illustrates a front view of a ceiling mounted class divider including a transparent panel having a transparent material in communication with a transparency control system, where the transparent material is configured to be opaque or translucent according to an example;

FIG. 3A illustrates a top view block diagram of an exemplary light emitting diode (LED) washlight module;

FIGS. 3B-3C illustrate perspective and front views of a washlight module in assembled form;

FIG. 4A illustrates a top perspective view of an aircraft passenger suite;

FIG. 4B illustrates a zoomed in view of a partition wall between aircraft passenger suite;

FIG. 4C illustrates an aisle-side perspective view of an aircraft passenger suite;

FIG. 5 illustrates a hardware block diagram of a system for controlling illumination of an aircraft interior surface; and

FIG. 6 illustrates a flow diagram of a method for controlling illumination of an aircraft interior surface.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

Aspects of the present disclosure are directed to aircraft surfaces and more particularly to the field of aircraft interior surfaces. In some implementations, graphic design elements can be applied to transparent interior aircraft surfaces, which can be illuminated by wash lights or other aircraft lighting systems to achieve a desired effect. The graphic design elements can be applied to the transparent surfaces using various methods and techniques based on the type of transparent surface, a desired permanency of the graphic design on the transparent surface, and other factors. In certain embodiments, the graphic design elements may include abstract designs, artwork indicia, advertising indicia that may include product advertisements or brand logos, or any other designs or information that can be viewed by passengers. Aspects of the present disclosure are also directed to methods for illuminating the transparent surfaces with an applied graphical design. For example, passenger suites or seats may include a variety of sensors that can be used to determine a status of a passenger, which may include whether the passenger is awake, asleep, eating, etc. In some implementations, the status of the passenger can be used to determine how to illuminate the transparent surfaces.

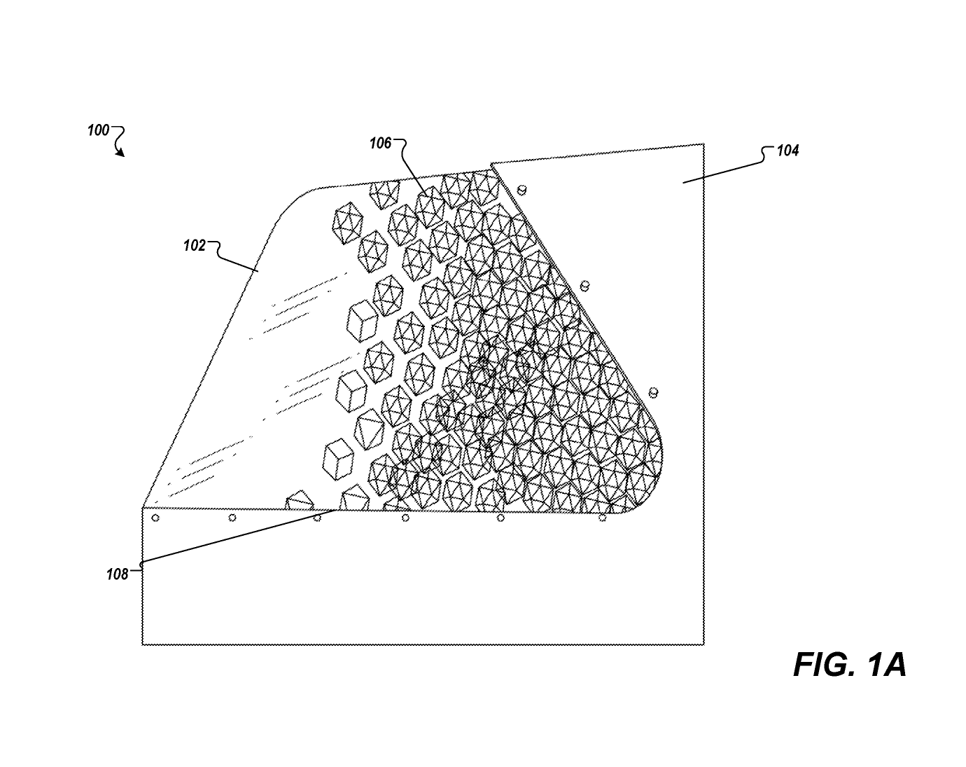

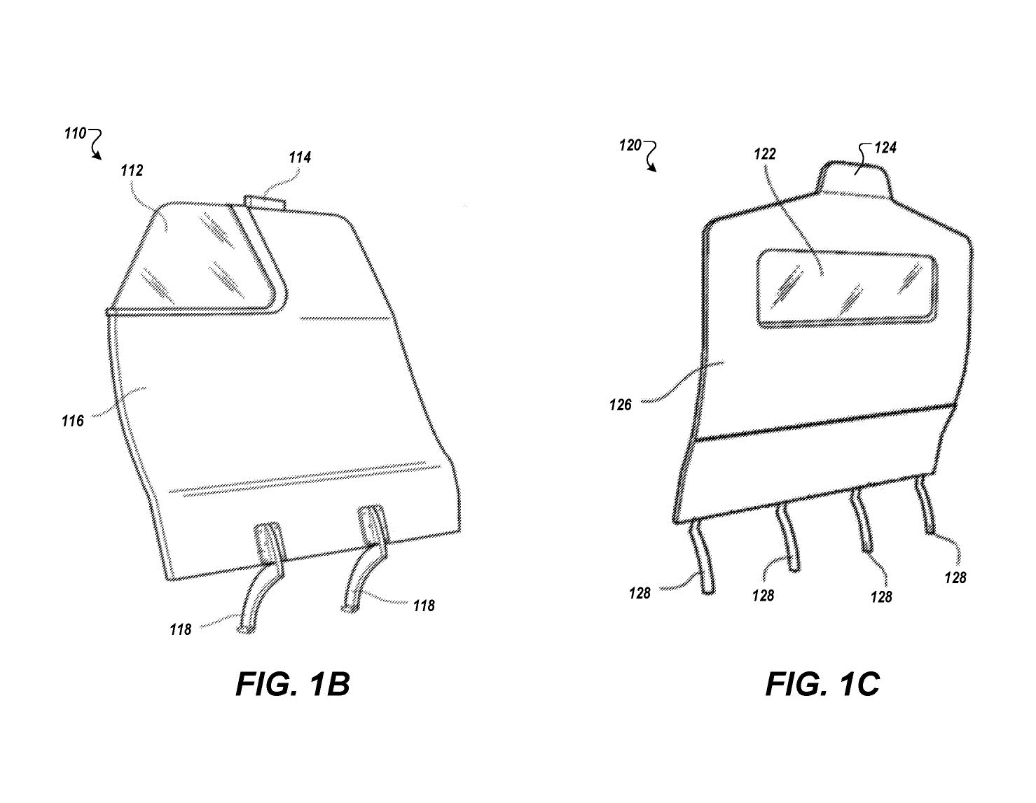

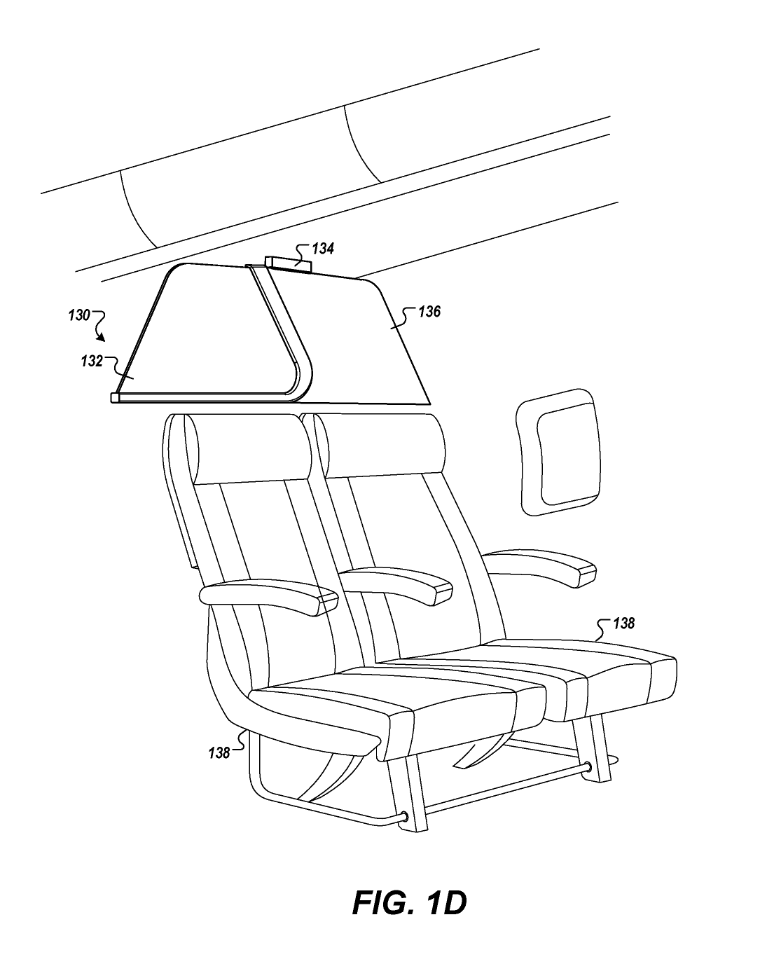

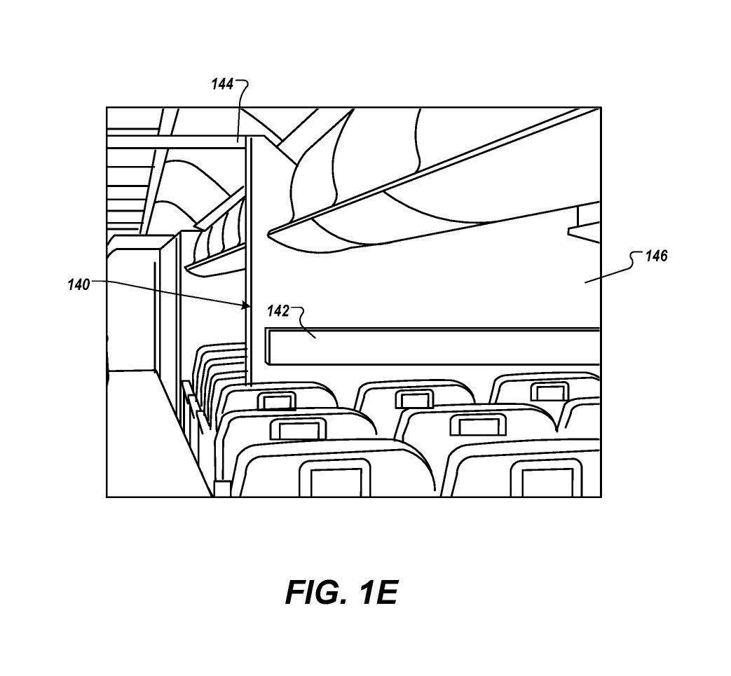

Turning to FIG. 1A, a perspective view of an aircraft interior surface 100 is illustrated. In some implementations, the aircraft interior surface 100 may include one or more connected panels that tray be movable or stationary based on the location and functionality of the panels. For example, the aircraft interior surface 100 may be a privacy panel for a premium class passenger suite that includes a transparent panel 102 in an upper region of the aircraft interior surface 100 that is connected to an opaque pan& 104 that forms the remainder of the privacy panel. In some implementations, the opaque panel 104 provides a support structure for the transparent panel 102. The transparent panel 102 may be connected to the opaque panel 104 by any type of connection means such as screws, nuts, bolts, etc. In some aspects, the opaque panel 104 includes grooves that have a shape that is complementary with a shape and dimension of edges of the transparent panel 102 such that the edges of transparent panel 102 are configured to be inserted into the grooves of the opaque panel 104.

In some embodiments, the transparent panel 102 is located in a region of the aircraft interior surface that allows light to pass into an area of the cabin, such as into the passenger suite, but has a minimal effect on the privacy provided to the passenger by the interior surface 100. For example, the transparent panel 102 may be located in the upper region of the interior surface 100 that is higher than a height at which a passenger seat is located while the opaque panel 104 covers a lower region of the interior surface that corresponds to a height at which the passenger seat is located. In other implementations, the transparent panel 102 may be positioned at a height of the surface that corresponds to eye level for a seated passenger so that the passenger is able to look through the transparent panel 102 and into an aisle, at another passenger in an adjacent seat, or into another portion of the aircraft cabin. In other embodiments, the entire surface 100 is composed of the transparent panel 102 and does not include the opaque panel 104.

Turning to FIG. 1B, a perspective view of a class divider 110 including a transparent panel 112 in an upper region of the class divider 110 is illustrated. The transparent panel 112 may be connected to a ceiling mount 114 that is connected to an opaque panel 116 having a set of supports 118 that form the remainder of the class divider 110. In some implementations, the opaque panel 116 provides a support structure for the transparent panel 112. In some implementations, the transparent panel 112 can be in communication with the transparency control system through the ceiling mount 114 which can include circuity configured to control power to the transparent material. In other examples, the transparent panel 112 can receive communications and electrical connection through the lower opaque panel 116, for example in embodiments where the ceiling mount 114 is configured for actuation.

Turning to FIG. 1C, a perspective view of a center divider 120 including a transparent panel 122 within a central portion of the center divider 120 is illustrated. The transparent panel 122 may be connected to a ceiling mount 124 that is connected to an opaque panel 126 having a set of supports 128 that form the remainder of the center divider 120. In some implementations, the transparent panel 122 can be in communication with the transparency control system through the ceiling mount 124 which can include circuity configured to control power to the transparent material. The opaque panel 126 provides a support structure for the transparent panel 122 as well as wiring between the ceiling mount 124 and the transparent material according to an example.

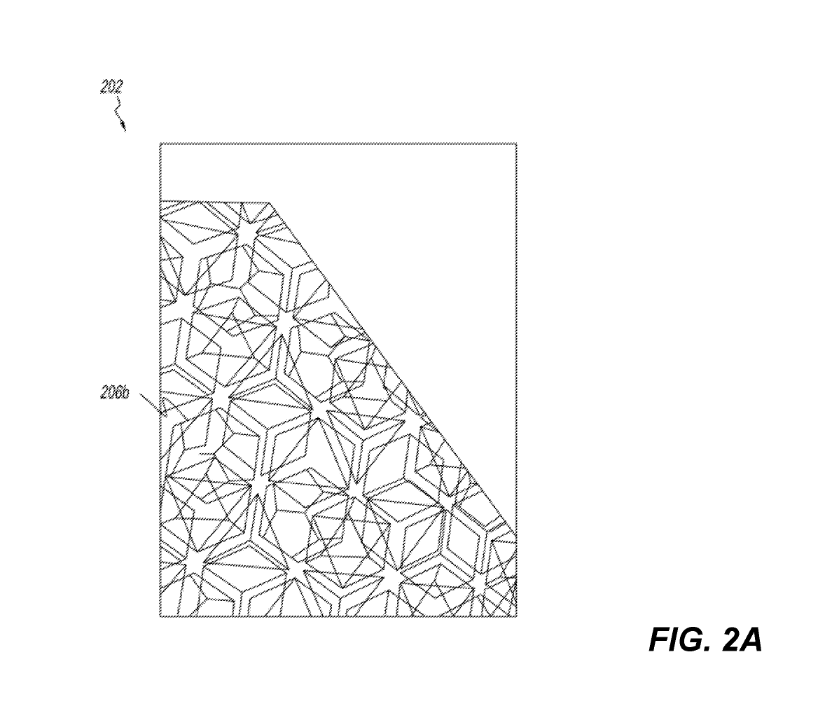

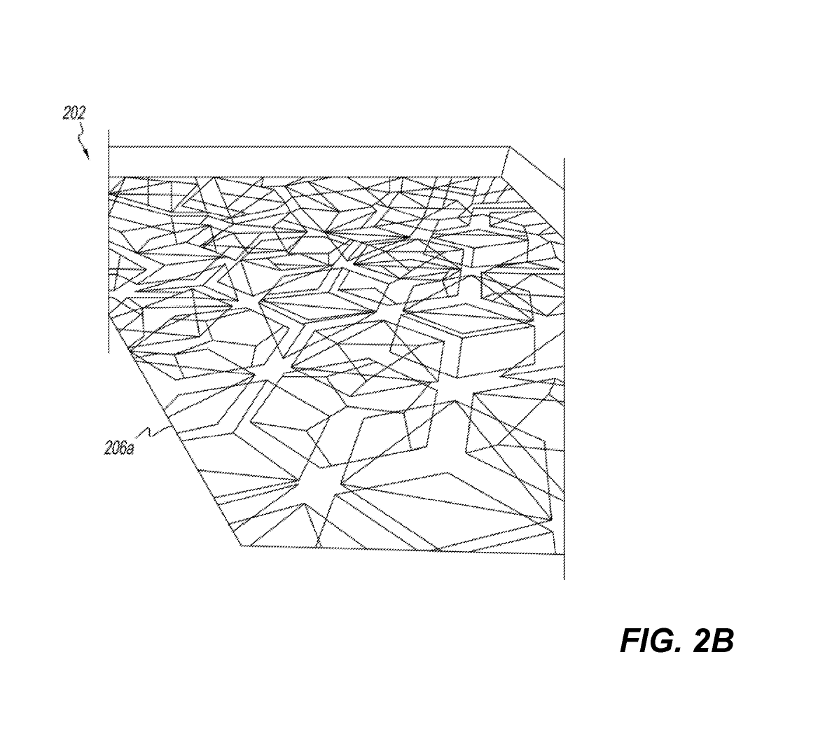

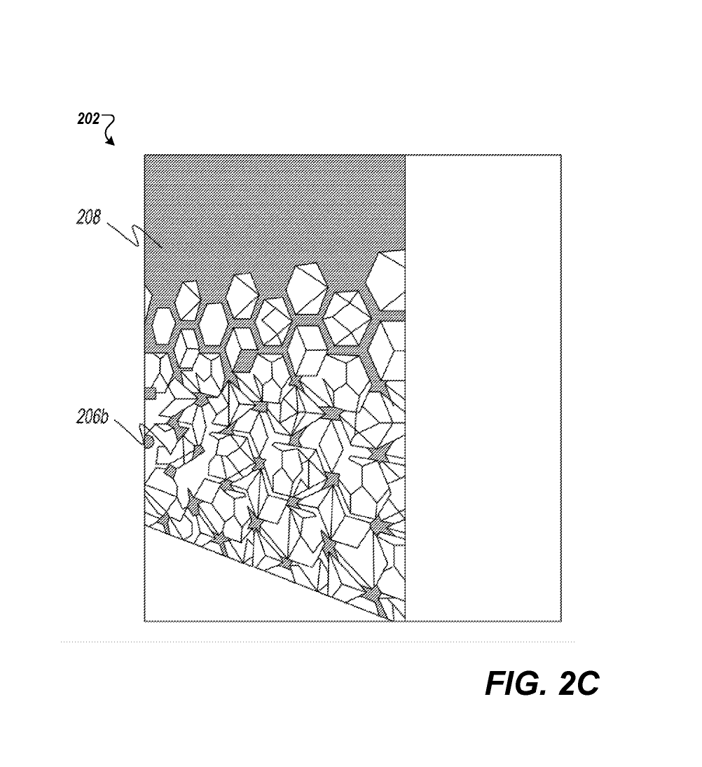

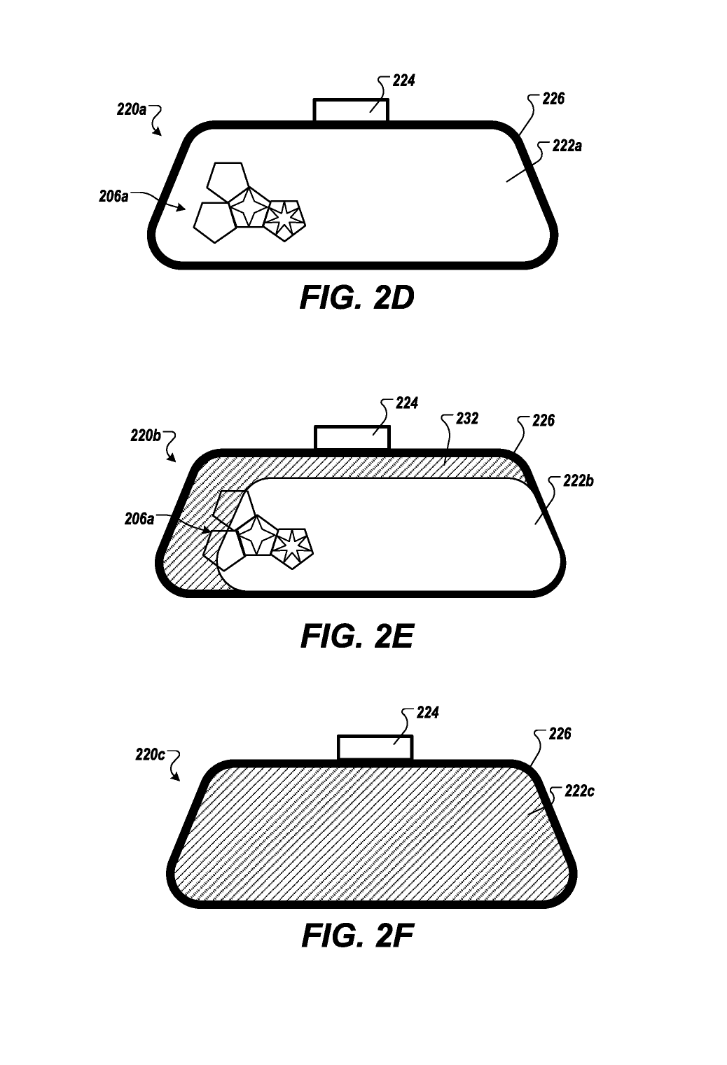

Turning to FIG. 1D, a perspective view of a ceiling mounted class divider 130 including a transparent panel 132 within a portion of the ceiling mounted class divider 130 is illustrated. In an example, the ceiling mounted class divider 130 can connect to an aircraft ceiling or storage unit above one or more passenger seats 138. In an example, the transparent panel 132 may be connected to a ceiling mount 134 that is connected to an opaque panel 136 that forms the remainder of the ceiling mounted class divider 130. In another example, the opaque panel 136 may be a thin frame that surrounds the transparent panel 132 (See FIGS. 2D-2F). In some implementations, the transparent panel 132 can be in communication with the transparency control system through the ceiling mount 134 which can include circuity configured to control power to the transparent material. The opaque panel 136 may provide a support structure for the transparent panel 132 as well as wiring between the ceiling mount 134 and the transparent material according to an example.

Turning to FIG. 1E, a perspective view of a cabin wall 140 including a transparent panel 142 within a central portion of the cabin wall 140 is illustrated. The transparent panel 142 may be connected to a ceiling mount 144 that is connected to an opaque panel 146 that forms the remainder of the cabin wall 140. In some implementations, the transparent panel 142 can be in communication with the transparency control system through the ceiling mount 144 which can include circuity configured to control power to the transparent material. The opaque panel 146 provides a support structure for the transparent panel 142 as well as wiring between the ceiling mount 144 and the transparent material according to an example.

In some embodiments, the transparent panel 102 is integrated into other types of aircraft interior surfaces. For example, the transparent panel 102 may be included in at least a portion of overhead bin doors, galley doors, and other compartment doors in an aircraft cabin so that the contents stored within the overhead bins and compartments can be viewed on an exterior side without opening the bins or compartments. In addition, the transparent panel 102 can be included as at least a portion of tray tables, arm rests, storage consoles, etc. In addition, the transparent panel 102 may be configured as one of the layers of a passenger fuselage window assembly.

In some implementations, the transparent panel 102 may be made of any type of transparent material including glass, plastic, crystal, acrylic, polycarbonate, polystyrene, cellulose, ceramic, lacquer, urethane, epoxy, resin, and combinations thereof. The transparent panel 102 may also be made of other materials than those described herein. The type of transparent material used for the transparent panel 102 may be based on material properties of the transparent material that are suited to a location and function of the transparent panel 102 within the aircraft cabin. For example, in implementations where the transparent panel 102 is part of an aisle-side panel that may be subject to repeated collisions with people, luggage, and galley carts, a strong yet ductile material may be selected that may include types of plastic, polycarbonate, or polystyrene may be used. In other examples where the transparent panel 102 may be included as part of an aircraft interior surface that is less likely to collide with other objects, such as for various types of panels within a premium class passenger suite, more brittle types of transparent material, such as glass, may be used.

The type of transparent material may also be selected based on other factors such as cost of the transparent material. In some implementations, the transparent panel 102 includes a graphical design 106 applied to the surface of the transparent panel 102 that may portray a seasonal branding or advertising design that may be replaced by another transparent panel 102 at the end of a season or advertising period. In such examples where the transparent panel 102 is installed for a temporary period of time, less expensive materials may be used to fabricate the transparent panel 102. For other examples where the transparent panel 102 is part of the aircraft cabin furniture that remains installed for long periods of time, such as years between aircraft maintenance overhauls, more expensive, durable transparent materials may be used. In addition, the type of transparent material that is selected may be based on a weight of the transparent material in order to meet aircraft weight restrictions.

In some implementations, the transparent panel 102 may include multiple layers. For example, the transparent panel may include multiple layers of various transparent materials that may include both solid panel and coating layers. In one example, the transparent panel 102 may be made of a plastic material that is covered with a coating of lacquer, epoxy resin, or urethane. In addition, the transparent panel 102 may be applied or adhered to a non-transparent layer of the aircraft interior. For example, aircraft interior surfaces, such as privacy panels, tray tables, compartment doors, or parcels within passenger suites may include the transparent 102 adjacent to the non-transparent interior surface. In some examples, the transparent panel 102 may be directly applied to the non-transparent surface during manufacture of the aircraft interior surfaces such that the transparent panel 102 is permanently or semi-permanently attached to the non-transparent surface. In other examples, the transparent panel 102 is configured to snap or slide into grooves in the non-transparent surface or connect to the non-transparent surface by some other means that provides for easily removing and/or replacing the transparent surface for repair or replacement. For example, the transparent surface may be replaced with another transparent panel 102 that reflects an updated brand logo or other advertising indicia.

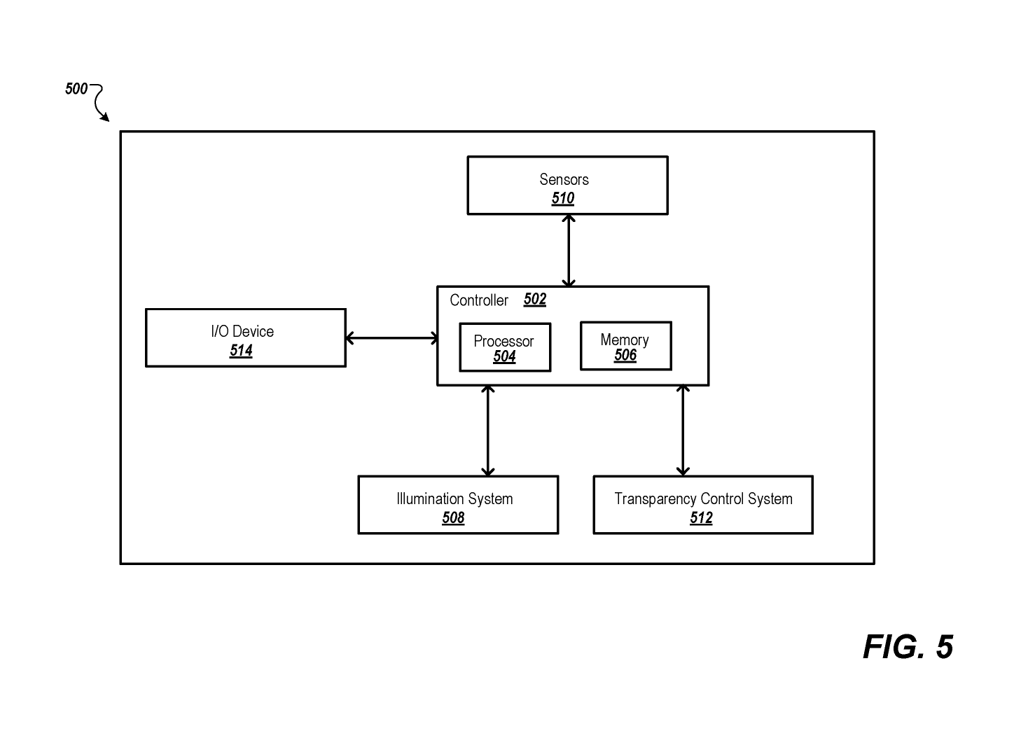

In some implementations, the transparent panel 102, instead of or in addition to a layer of transparent material, may include an electronic glass layer that is configured to adjust an amount of transparency of the electronic glass layer based on an applied voltage, which can aid in improving the amount of privacy provided by the transparent panel 102. For example, the electronic glass layer can change light transmission properties to exhibit varied amounts of transparency, translucency, or opacity based on the applied voltage. In some implementations, the amount of voltage supplied to the electronic glass layer of the transparent panel 102 may controlled by a controller 502 (FIG. 5) that determines the light transmission properties of the electronic glass layer based on predetermined settings, inputs received from a passenger or flight attendant at an input/output (I/O) device such as a touchscreen video monitor at a passenger suite or flight attendant station.

For example, for an electronic glass layer associated with an aisle-side privacy panel separating a passenger suite from an aisle of the aircraft cabin, a passenger seated in the passenger suite may select a transparent setting for the electronic glass layer at the I/O device when the passenger desires to increase the amount of light that entering the passenger suite from the aircraft cabin. Similarly, if the passenger desires to increase the amount of privacy and/or reduce the amount of light entering the passenger suite, such as when the passenger sleeping, the passenger may select a setting at the I/O device to adjust the electronic glass layer to exhibit varied amounts of translucency of opacity.

As used herein, the term “opaque” means having at least 50% opacity. The term opaque therefore includes translucent materials. In various embodiments, the dimmable panel provides 50, 60, 70, 80, 90 or 100 percent opacity and values therebetween.

According to an embodiment, a transparent panel can include a transparent material such as a suspended particle laminate having suspended rod-like nano-scale particles within a liquid or gel sandwiched between a glass or plastic. In an example, an amount of transparency of the transparent panel can be controlled by applying a voltage to the suspended particle laminate. In an example, when no voltage is applied, the suspended particles are randomly organized, thus blocking and absorbing light. When an activating voltage is applied, the suspended particles align and let light pass. In an example, the suspended particles can be configured to be sensitive to a magnetic field and the activating voltage can induce a magnetic field to align them. In another example, the suspended particles can have a chemical polarity and the activating voltage can trigger a reversible oxidation/reduction reaction and thereby aligning the suspended particles. In this case, while the voltage and power required may be less than using the magnetic field, maintaining an active state (either transparent or non-transparent with applied voltage) may reduce lifetime of materials.

According to an embodiment, a transparent panel can include a transparent material including a thin coating of nanocrystals embedded in a glass configured to provide selective control over both visible light and heat-producing near-infrared (“NIR”) light. The nanocrystals can be made of indium tin oxide and can be embedded in a glassy matrix of niobium oxide to form a composite material operating with a voltage range of about 2.5 volts according to an example. In an example, the transparency control system can be configured to provide a small jolt of electricity to switch the transparent material between an NIR-transmitting and an NIR-blocking state. In an aspect, the transparent panel utilizing the thin coating of nanocrystals can be switched to a dark mode, blocking both light and heat, or to a bright, fully transparent mode. The dark mode takes advantage of a synergistic interaction in a region where a glassy matrix meets nanocrystal which increases an electrochromic effect. The synergistic interaction allows atoms to connect across the nanocrystal-glass interface, causing a structural rearrangement in the glass matrix. This interaction creates space inside the glass, allowing charge to move more readily.

In some implementations, the transparent panel 102 may include a graphical design 106 that may be applied through various means based on the type of material of the transparent panel 102, function of the transparent panel 102, location of the transparent panel 102 within the aircraft cabin, and type of graphical design 106. For example, the graphical design 106 by be printed directly to the transparent panel 102, applied in sheet form to the transparent panel 102, or integrated into the transparent surface at the time of manufacture. For example, the integration of the graphical design 106 into the transparent surface may involve etching the graphical design 106 into the transparent panel 102 and filling in the etched surfaces with desired colors or patterns.

In some implementations, the graphical design 106 may be printed directly to the transparent panel 102 or integrated into the transparent surface at the time of manufacture for permanent or non-seasonal graphical designs that are not time-sensitive or may not need to be changed for long periods of time. For example, permanent or non season graphical designs may include long-standing airline or brand logos or abstract artwork and/or patterns that are not associated with a particular period of time. In addition, the graphical design 106 applied in sheet form to the transparent panel 102 may also be applied with a permanent adhesive for permanent or non-seasonal graphical designs.

In some examples, the sheet form of the graphical design 106 may also be applied with a semi-permanent or removable adhesive on one side of the sheet that allows the graphical design to be removed from the transparent panel 102 by peeling the graphical design 106 away from the transparent panel 102, application of heat to the transparent surface to loosen the adhesive adhering the graphical design 106 to the transparent panel 102, or any other removal means associated with the adhesive. Appling the sheet form of the graphical design 106 to the transparent panel 102 with the semi-permanent or removable adhesive may be used for temporary and/or seasonal graphical designs that may be changed on a periodic basis. For example, temporary or seasonal graphical designs may include advertisements for food and beverages that may be served on the aircraft for a period of time, advertisements for airline credit cards or other promotions provided by the airline on a temporary basis, graphical designs that reflect a specific season or holiday, and brand or product logos that include features that may change periodically.

FIGS. 2A-2C provide illustrative examples of graphical designs 206 applied to the surface of a transparent panel 202. For example, FIGS. 2A-2B illustrate perspective views of a first graphical design 206a applied to the surface of the transparent panel 202. The first graphical design 206a includes an abstract pattern that may be applied to the transparent panel 202 of an interior surface within an aircraft cabin. For example, the graphical design 206a may be applied to a transparent panel 202 that forms at least a portion of a privacy panel, door to an overhead storage bin, tray table, and the like. In some implementations, since the graphical design 206a does not include indicia for any type of product, advertisement, or branding logo, the graphical design 206a may be applied to transparent surfaces that are outside of a direct field of view of a passenger when the passenger is seated in an aircraft seat or suite. In some examples, graphical designs that include product and/or branding logos may be placed on transparent panels that are within the field of view of the passenger for the greatest amount of time during a flight to increase exposure of the passenger to product/branding logos and advertisement indicia.

In addition, the graphical design 206a includes a clear/transparent background or no background such that the indicia for the pattern of the graphical design 206a are applied. directly onto the transparent panel 202. For example, the graphical design 206a includes multiple lines arranged in a predetermined abstract pattern with areas in between the lines of the pattern expose the transparent panel 202. In some implementations, including patterns of graphical design indicia and exposed portions of the transparent panel 202 may allow greater amounts of light to pass through the transparent panel 202 than graphical designs that cover some or most of the transparent panel 202 without any exposed portions of the transparent panel 202 throughout the graphical design 206a. In addition, the graphical design 206a that includes exposed portions of transparent panel 202 throughout the design may be able to be viewed from both sides of the transparent panel 202.

In some embodiments, the aircraft interior surface 100 may include an illumination system 108 that is disposed within, adjacent to, or directed at the aircraft interior surface 100 to provide illumination for the aircraft interior surface 100 (FIG. 1A). In some examples, the illumination system 108 may output varied colors that cause the graphical design 206a to reflect the colors of light output by the illumination system 108 or a combination of color output by the illumination system 108 and effects upon the color caused by one or more properties of the indicia of the graphical design 206a.

In some implementations, the lines of the indicia of the graphical design 206a may be colored and/or applied based on the properties of the transparent panel 202 as well as a type (e.g., direction, color, intensity, etc.) of illumination intended to be applied to the transparent panel 202. Certain lines of the indicia of the graphical design 206a may be applied differently to have different effects upon illumination. For example, some lines may be highly reflective to accentuate the portion of the indicia upon illumination, while other lines may be matte to diffuse the effect of lightwashing. In another example, a prismatic powder coating may be applied to portions of the graphical design 206a to create a multi-tone (“rainbow”) effect upon illumination. In a further example, holographic flakes may be embedding into a coating of a portion of the graphical design 206a to cause a prismatic “glitter” effect upon illumination. In some embodiments, a semi-opaque design may be applied to the transparent panel such that the design is muted or disappears absent illumination. In an additional example, three-dimensional effects may be applied in the graphical design 206a, including light deflection surfaces to deflect light across the transparent panel 202 in a pattern.

In some implementations, the illumination system 108 may include one or more light sources embedded between connection surfaces of the transparent panel 106 and the opaque panel 104. In one example, the lines of the graphical design 206a have a white color so that the lines of the graphical design 206a display the color of light output by the illumination system 108.

FIG. 2C illustrates a perspective view of a second graphical design 206b applied to the surface of the transparent panel 202. The second graphical design 206b also includes an abstract pattern that may be applied to the transparent panel 202 of an interior surface within an aircraft caber. In some examples, the indicia of the graphical design 206b may include a solid or patterned background 208 that may be included as part of the graphical design 206b and may be have a different color than the graphical design 206b such that the pattern of the graphical design 206b is highlighted against the background 208. In some implementations where the graphical design 206b is applied as a sheet to the transparent panel 202, the graphical design 206b and background 208 may be applied as a single sheet to the transparent panel 202. In other examples, the background 208 and graphical design 206b may be applied as layered sheets such that a background sheet is applied to the transparent panel 202, and a graphical design sheet is overlaid on top of the background sheet. The background 208 may be included as part of the graphical design 206b for the transparent panel 202 at locations within the aircraft cabin where privacy may be prioritized over light transmission. For example, the transparent panel with the graphical design 206b may be included in at least a portion of a privacy panel separating two aircraft suites or seats.

In some implementations, the graphical design 206b that includes the background 208 may also be applied to each side of the transparent surface. For example, each side of the transparent surface may have a different graphical design 208b.

In addition, indicia of the graphical design 206b as well as the background 208 may be colored based on the properties of the transparent panel 202 as well as a type and color of illumination applied to the transparent panel 202. In one example, the indicia of the graphical design 206b have a white color so that the graphical design 206b displays the color of light output by the illumination system 108. In addition, the background 208 may have a color that is different than the color of the graphical design, such as grey.

Turning to FIG. 2D, a front view of a ceiling mounted class divider 220a including a transparent panel 222a having a transparent material, a frame 226 surrounding the transparent panel 222a and connected to a ceiling mount 224 in communication with a transparency control system is illustrated. In an example, the transparent material can further include the graphical design 206a. As shown in FIG. 2E, the transparency control system can be configured to only activate a portion 232 of the transparent material to become opaque or translucent. A portion of the transparent panel 222b remains transparent. FIG. 2F illustrates a front view of a ceiling mounted class divider 220c including a transparent panel 222c having a transparent material in communication with a transparency control system, where the transparent material is configured to be fully opaque or translucent according to an example.

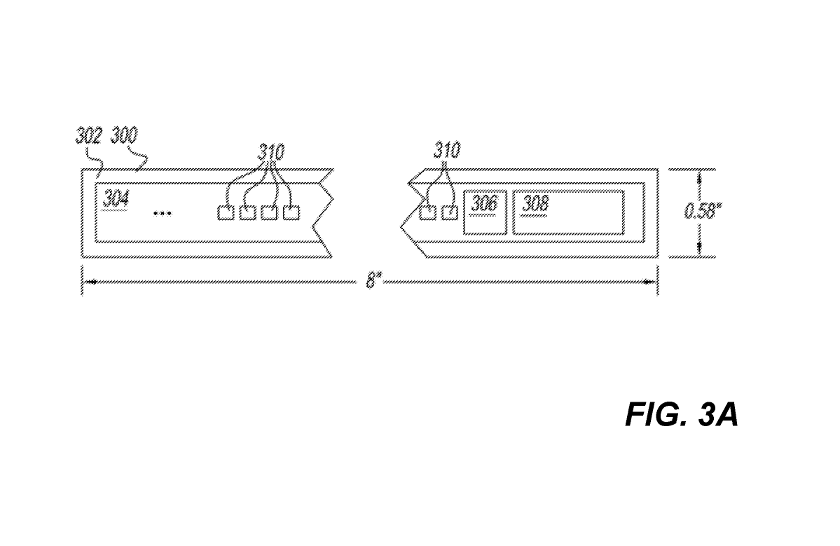

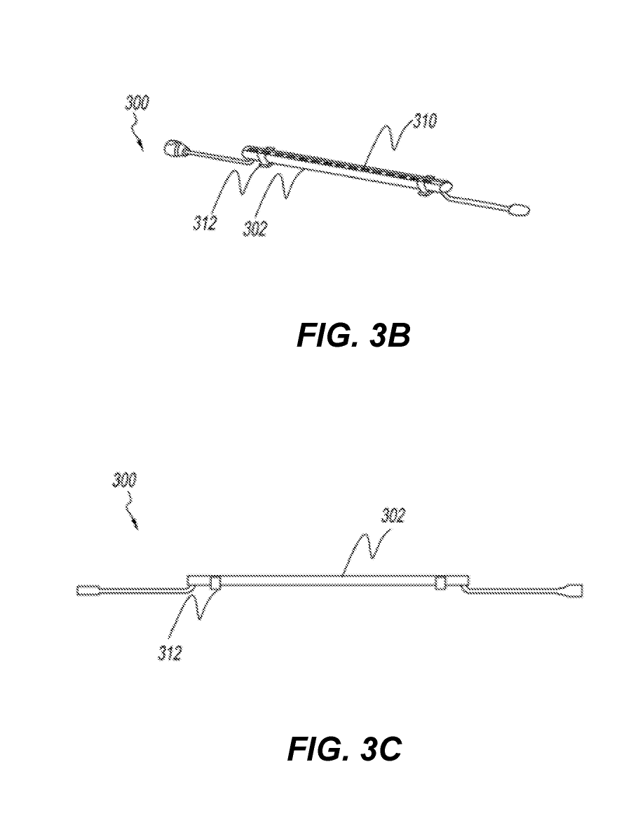

Referring back to FIG. 1A, the aircraft interior surface 100 may include an illumination system 108 that is disposed within, adjacent to, or directed at the aircraft interior surface 100 to provide illumination for the aircraft interior surface 100. In some implementations, the illumination system 108 may include one or more washlights with light emitting diodes (LEDs) or other illumination devices configured to output colored light onto the transparent panel 102. FIG. 3 is an illustrative example of a washlight 300 that may be included as part of the illumination system 108 for the aircraft interior surface 100. The washlight 300 described below is a non-limiting example, and other washlight configurations or structures can also be used to illuminate the transparent panel 102 of the aircraft interior surface 100.

The washlight 300 may include a housing 302 that may be made of a metallic extrusion. Implementations of the present disclosure may include a set of different length washlights 300 having integer multipliers of some underlying measurement value. For example, one version of the module may be designed to have a length that is 8″ (an underlying measurement value of 4″ with a multiplier of 2), although a related series of modules are envisioned having lengths of 12″, 16″, etc., accordingly (multipliers of 3, 4, etc., i.e., in steps of 4″), so that modules can be purchased to fill a wide variety of spaces on a number of different aircraft designs. More generally, the lengths of modules can be expressed as m×n″, where n=4″ and m is a set of integer values from 2 to 24.

In some implementations, the component washlight 300 may include one or more printed circuit boards (PCB) 304 that includes a power supply 306, module controller 308, and LEDs 310. In one example, the LEDs 310 may be arranged in a linear array across the PCB(s) 304, and, e.g., in a red, green, blue (RGB), and white configuration. In some implementations, the combination of light output from the RGB and white LEDs may correspond to a specific color in the visible light spectrum. The power supply 306 and module controller 308 can be integrated together. The power supply 306 can be designed to run based on 28 VDC, but should be able to operate over a range, e.g., from 18 VDC to 30.3 VDC. Since the input to the module is DC, there may be a single power supply, a single DC switch, and it is not necessary to have an isolated design such that the power supply can be referenced to the aircraft chassis. In some implementations, the washlight 300 may be designed to consume approximately 6 Watts per foot. Appropriate filtering and shielding may also be provided to cancel radiated energy, conducted EMI, spike surges, etc.

The washlight 300 may also include a thermal management system coupled with a thermal heat sinking design. In addition, the washlight 300 may include a temperature sensor that monitors the internal temperature of the washlight 300 and regulates LED PWM duty cycles to maintain an optimal operating temperature and calibrated light output within predetermined temperature specifications for the LEDs 310 of the washlight 300. Further, FIGS. 3B-3C illustrate perspective and front views of the washlight 300 in assembled form with different types of connectors and clips 312 or other type of mounting device connected to the housing that provide for connecting the washlight 300 to a connection point within or adjacent to the aircraft interior surface 100.

Referring back to FIG. 1A, the illumination system 108 for the aircraft interior surface 100 may include one or more illumination devices, such as the washlight 300, which may be integrated into the structure of the aircraft interior surface 100. For example, the illumination system 108 may be disposed at connection points or surfaces between the transparent panel 102 and the opaque panel 104 such that the illumination sources (e.g., LEDs) of the illumination system 108 are directed toward the transparent panel 102. In addition, the illumination system 108 may be located at other locations within the aircraft cabin that are facing the transparent surface such that the illumination sources can be directed toward the transparent panel 102.

In some examples, the illumination system 108 may include a controller 502 (FIG. 5) that is configured to control the illumination of the transparent panel 102 as well as other transparent panels within the aircraft cabin based on various criteria that may include received inputs from the passenger or flight attendant at an I/O device, a sensed status of the passenger within a suite or seat, sensed characteristics of the light within the aircraft cabin, the type of graphical design displayed on the transparent device, an effect of the illumination output by the illumination on adjacent suites or compartments, or received inputs from a user. For example, if the controller 502 detects that the amount of light within the cabin has decreased below a threshold, which may occur when the sun sets or when the cabin lights are dimmed, the controller 502 may output a control signal to the illumination system 108 to increase the intensity of light output by the washlights 300 illuminating the transparent panel 102. In addition, if the transparent panel 102 is part of a privacy panel separating two adjacent suites, and a passenger requests an increase in the amount of illumination applied to the transparent panel, the controller 502 may output a message to a suite video monitor indicating that the request is denied because the seat of the passenger in an adjacent suite is in the lie-flat position, indicating that the adjacent passenger may be asleep. In some implementations, the controller 502 can output control signals to the illumination system 108 to adjust a color, color pattern, intensity, or other characteristics of light output by the illumination devices. In some examples, the controller 502 outputs control signals to the local controller 308 of each washlight 300 (FIG. 3), and the local controller 308 locally controls the output of light from the LEDs 310 of the washlight 300.

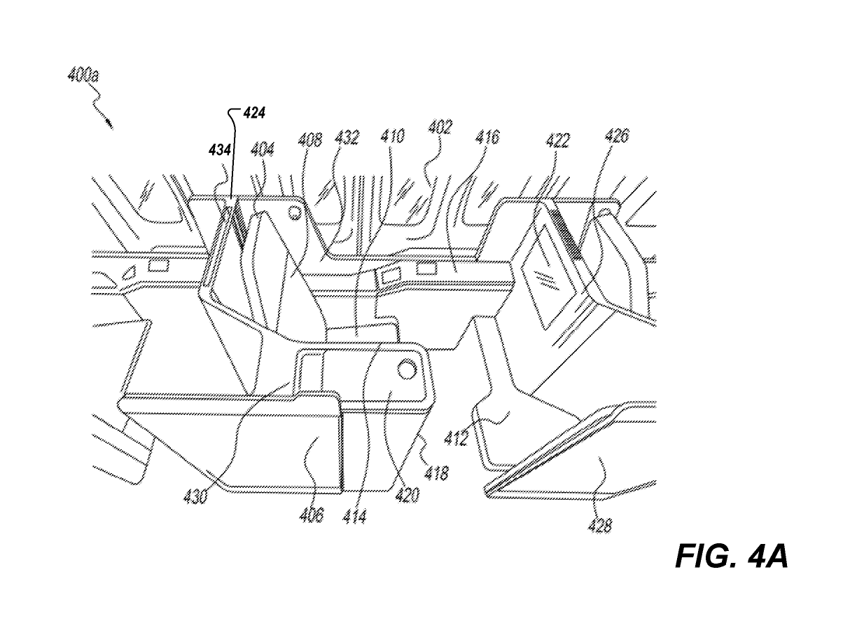

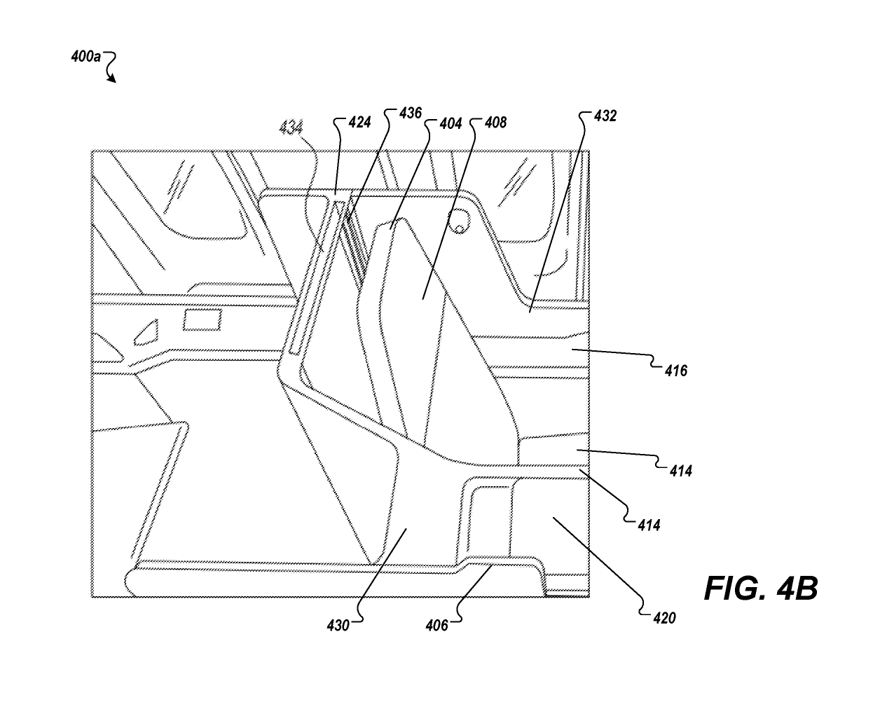

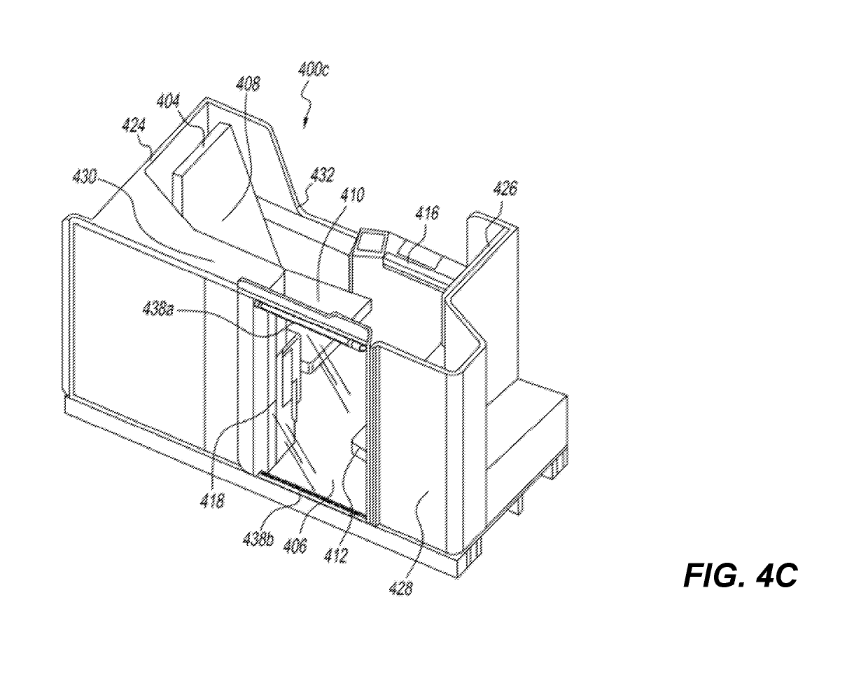

Turning to FIGS. 4A-4C, views of passenger suites within an aircraft cabin are illustrated that may include one or more surfaces that include implementations of the transparent panel described above. For example, FIG. 4A illustrates a top perspective view of an aircraft passenger suite 400a adjacent to fuselage windows 402 within an aircraft cabin, FIG. 4B illustrates a zoomed in view of a partition wall 424 between two adjacent passenger suites, and FIG. 4C illustrates an aisle-side perspective view of the passenger suite 400c including a transparent panel door 406 in a closed position that covers an ingress/egress path into and out of the suite 400. In some implementations, the passenger suite 400 includes an adjustable seat 404 for the passenger along with various compartments and amenities. The seat 404 may be a lie-flat capable seat including a seat back 408 and seat bottom 410 configured to selectively move between an upright taxi, take-off and landing (TTOL) position and a horizontal lie-flat position in which the seat back 408 and seat bottom 410 cooperatively form a generally flat planar bed surface. Movement of the seat may be accomplished through conventional mechanisms. The seat 404 is positioned at one corner of the suite and an ottoman 412 may be provided along the forward wall, with a wide portion of the ottoman 412 being located at the opposing corner from the seat. The wide portion of the ottoman 412 may serve as a temporary seat for a suite visitor. An aisle-side partition 428 adjacent to the ottoman may provide a portion of a boundary between an interior of the suite 400 and an aisle. Right and left armrest assemblies 414, 416 are positioned alongside the seat 404. A closet 418 is positioned alongside the right side armrest 414 along the aisle and is configured for storage, housing suite controls, providing a working surface 420, etc. In some examples, the closet 418 also defines a portion of the aisle wall. The suite 400 may also include right and left privacy panels 430, 432 on either side of the seat 408 that shield the passenger from view when seated in the seat 408.

In addition, a video monitor 422 is mounted on the forward partition wall 426 directly in front of the seat for the optimum viewing angle. In some implementations, the video monitor 422 functions as an I/O device that allows the passenger to modify settings associated with the transparent panels within the aircraft suite that may include adjustments to a color, color pattern, intensity, or other characteristics of light output by the illumination system associated with the transparent panels.

In some implementations, components of the suite 400 may include sensors that allow a controller 502 (FIG. 5) for the illumination system to determine a status of the passenger and modify the illumination settings of the transparent panels within the suite 400 based on the sensed status. For example, the armrests 414, 416 and working surface 420 may include pressure sensors that detect when the passenger has placed an object on the those surfaces, indicating that the passenger may be awake and eating and/or working. In some implementations, the controller 502 may increase an amount of illumination for transparent panels with graphical designs that include advertisements for food or drink if it is determined, in some examples, that it is approximately meal time, that the passenger has not been provided food for a threshold amount of time, and/or eating or drinking. Further, advertisements may be selectively highlighted based in part on whether or not it is suspected that the passenger is awake. In a particular example, the actuators for the seat 404 may include pressure and/or contact sensors that provide an indication of whether the seat 404 is in an upright or lie-flat position, which may indicate whether the passenger is awake or asleep. The suite 400 may also include motion sensors at various points throughout the aircraft that can detect movement of the passenger. In some examples, based on the sensor data received from the motion sensors, the controller 502 may determine that the passenger has exited or entered the suite 400 or that the passenger is moving and awake or not moving, indicating that the passenger may have drifted off to sleep. In addition, a door to closet 418 as well as doors to other compartments within the suite 400 may include one or more contact sensors that indicate whether the passenger has opened or closed the door to the closet 418 or compartment.

In some embodiments, partition walls surround the suite 400 and define the passenger living area or space. Included in the passenger living area is the seat 404, closet 418, ottoman 412, armrests 414, 416 and floor space, among other amenities. The partitions can include multiple walls arranged to form one continuous wall with the exception of the suite opening. Walls of the suite 400 may also serve as walls of an adjacent suite. For example, rear partition wall 424 may serve as the forward partition wall of the adjacent suite. The partition walls, for example, may extend from the floor to a height about equal to the top of the seat back 408 in the upright position. Wall height may be increased or decreased when designing the suite to enhance or relax privacy. In some examples where the partitions for the suite 400 include transparent panels with applied graphical designs as described above, the wall height may be increased, and the transparent panels may be included in at least an upper region of the partition walls to provide additional privacy to the passenger while still allowing light to pass through the transparent panels.

In some implementations, any of the components, amenities, or partition walls of the suite 400 described above may include one of the embodiments of the transparent panel 102 (FIG. 1A) that may include graphical designs applied to the transparent panel along with an illumination system that washes light across the transparent panel. For example, transparent panel door 406, partitions 424, 426, working surface 420, panels for armrests 414, 416, or a door for the closet 418 may include a single or multi-layer transparent panel that allows light to pass through the panel or may be configured adjacent to non-transparent interior surfaces. In some examples, the transparent panels may be directly applied to the non-transparent surface during manufacture of the aircraft interior surfaces such that the transparent e is permanently or semi-permanently attached to the non-transparent surface. In other examples, the transparent panel may be configured to snap or slide into grooves in the non-transparent surface or connect to the non-transparent surface by some other means that provides for easily removing and/or replacing the transparent surface 102 for repair or replacement.

For example, the transparent surface may be replaced with another transparent panel that reflects an updated brand logo or other advertising indicia 4B provides an illustrative example of a partition wall 424 between two adjacent suites that includes a slot 434 for receiving a replaceable transparent panel (not shown). The slot 404 may have dimensions that correspond to the dimensions of the transparent panel such that the transparent panel fits snuggly when inserted into the slot 434. In addition, the interior surfaces of the partition wall 424 may include a groove 436 that the transparent panel slides into when inserted into the slot 434. In some implementations, other panels and partitions within the aircraft suite 400 may also be configured with slots for receiving replaceable transparent panels. For example, an aircraft cabin may include suites 400 that are laterally separated by side partition walls and/or privacy panels that may also be configured with slots for receiving replaceable transparent panels.

In some implementations, the type of graphical designs applied to the transparent panels of the aircraft suite 400 may be based on a field of view of a passenger sitting in the seat 404. Transparent panels outside of the field of view of the passenger may include abstract patterns and/or artwork that are not associated with a type of product/brand logo or advertisement, such as the graphical designs 206 (FIGS. 2A-2B). For example, transparent panels for rear partition wall 424, transparent panel door 406, or a door for closet 418 may include such graphical designs without advertisements or logos. In some examples, graphical designs that include product and/or branding logos may be placed on transparent panels that are within the field of view of the passenger for the greatest amount of time during a flight to increase exposure of the passenger to product/branding logos and advertisement indicia. For example, transparent panels for forward partition wall 426 or working surface 418 may include logo and/or advertisement indicia.

In some examples the opening to the suite 400 is provided along the closet side of the suite and opens into the aisle to facilitate ingress/egress. As shown, a walkway is provided between the closet 418 and the ottoman 412. A door, the privacy panel 406, slides alongside the aisle side of the suite 400 between open and closed positions, separating the suite from the remainder of the aircraft cabin. The entire suite 400 may be enclosed by the privacy walls that cooperate with the transparent panel door 406 to provide the suite occupant the desired degree of privacy. The transparent panel door 406 may slide along a floor track or may be suspended from a wall track. In some examples, the transparent panel door 406 preferably has a nominal thickness so as to minimally protrude into the aisle.

Illumination devices, such as the washlights 300 (FIG. 3) for a transparent panel illumination system, are mounted in or around one or more of the edges of the transparent panel door 406 and other transparent panels within the suite 400 so that when they are illuminated, light is transmitted through the transparent panel door 406 providing colored illumination of the graphical design on the transparent panel door 406. For example, 4C provides an illustrative example of illumination devices 438 disposed around a periphery of the transparent panel door 406 that are configured to illuminate the surfaces of the transparent panel door 406. For example, a first illumination device 438a may be connected at an upper end of the transparent panel door 406 and is directed in a downward direction toward the transparent panel door 406. In addition, a second illumination device 438b may be connected near a lower end of the transparent door 406, such as along an ingress/egress plane to the suite 400c, and is directed upward toward the transparent panel door 406.

In some implementations, the ability to auto-switch the color of the screen illumination depending on whether the screen is open or closed permits the passenger or the crew to select the color of illumination for the privacy screen to convey information, such as “do not disturb”, “wake for next meal”, “crew attention required”, and the like. The color can also be locked to a particular color by the crew or automatically by controller 502 (FIG. 5) to indicate whether the privacy screen is open or closed. In addition, the transparent panel door 406 as well as any of the other transparent panels within the suite 400 may also include an electrochromic layer that is configured to adjust an amount of transparency of the transparent panel door 406 based on an applied voltage, which can aid in improving the amount of privacy provided by the transparent panel door 406 or other transparent panels within the suite 400.

Turning to FIG. 5, a hardware block diagram of an illumination system 500 for one or more transparent panels is illustrated. The components included in the block diagram of the system 500 are non-limiting and can include other components in addition to or instead of those described herein. In some implementations, the system 500 includes a controller 502 that controls the illumination systems for one or more transparent panels within the aircraft cabin. The controller 502 may include a processor 504, memory 506, and associated circuitry, and may be connected to an I/O device 514, illumination system 508, transparency control system 512, or sensors 510 via a wired or wireless network connection.

In some implementations, the controller 502 can be configured for determining adjustments to an illumination system 508 for a transparent panel based on predetermined criteria and outputting control signals to the local controllers 308 for the washlights 300 (FIG. 3) to modify the color, illumination intensity, and other characteristics of the washlights 300 to reflect the determined adjustments. Similarly, the controller 502, in some embodiments, can also determine an amount of transparency for transparent panels including an electronic glass technology within or upon the transparent material and can output an activation power or voltage or control signal to a transparency control system 512 to adjust the transparency of the transparent panel by adjusting the voltage applied to the transparent material.

In some examples, the predetermined criteria may include received inputs from the passenger or flight attendant at an I/O device 514, which can include a video monitor, mobile device, tablet, or other device connected to the controller 502 via a wired or wireless connection, a sensed status of the passenger within a suite or seat from one or more sensors 510, sensed characteristics of an amount of light within the aircraft cabin, the type of graphical design displayed on the transparent device, and/or an effect of the illumination output by the illumination on adjacent suites or compartments. In further examples, the adjustments may include adjustments based upon a flight status, such as a wheels down period, a take-off period, and/or a landing period of the flight. For example, one or more triggers for automated functionalities of the aircraft, such as flight preparation operations, may additionally trigger automated settings of the controller 502 for controlling aspects of the illumination. The controller 502, in some implementations, includes commands for adjusting illumination of and/or opacity of groupings of partitions within the passenger cabins. For example, divider partitions may be controlled as a set to ensure full transparency and visibility during take-off preparation. In some implementations, the controller 502 can output control signals to the illumination system 508 to adjust a color, color pattern, intensity, or other characteristics of light output by the illumination devices.

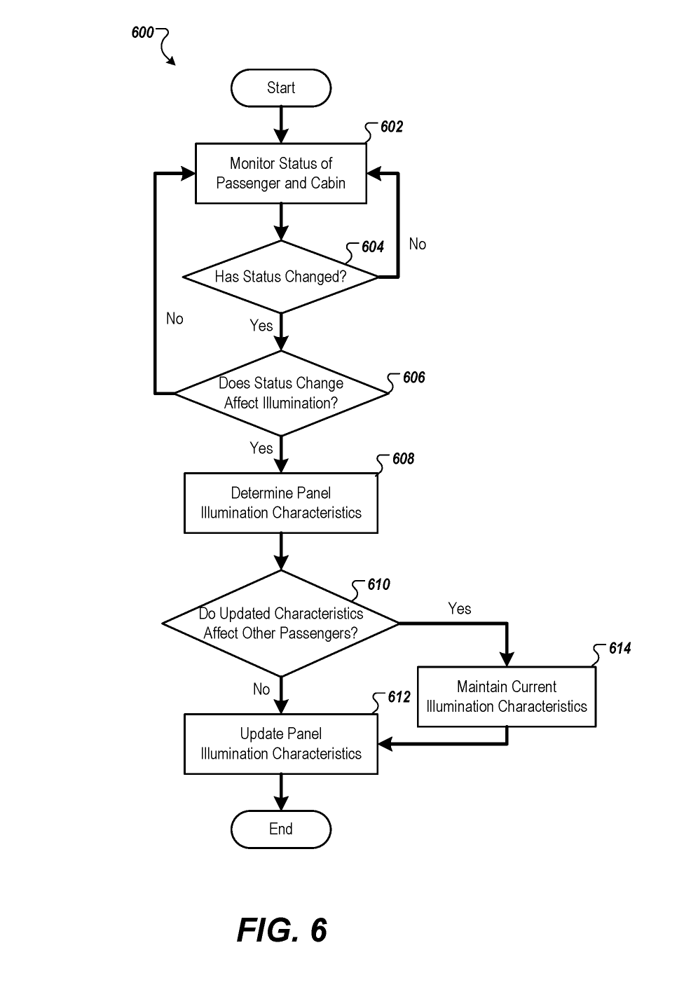

Turning to FIG. 6, a flow diagram of a method 600 for controlling illumination of an aircraft interior surface including a transparent panel is described. While the flow diagram in FIG. 6 shows an ordering of one or more blocks or steps, it can be understood that the blocks or steps of the method 600 may be executed in any order, in series, or in parallel with other steps.

In some implementations, the method begins by monitoring a status of a passenger within an aircraft suite as well as a status of an aircraft cabin (602). Monitoring the status of the passenger may include monitoring for inputs from the passenger at an I/O device, such as at a touchscreen monitor within the passenger suite as well as monitoring sensor data from received sensors within a passenger suite indicating that the passenger has awoken, gone to sleep, or entered/left the suite. For example, armrests and working surfaces within the suite may include pressure sensors that detect when the passenger has placed an object on the those surfaces, indicating that the passenger may be awake and eating and/or working. In addition, the actuators for a seat may include pressure and/or contact sensors that provide an indication of whether the seat s in an upright or lie-flat position, which may indicate whether the passenger is awake or asleep. The suite may also include motion sensors at various points throughout the aircraft that can detect movement of the passenger. In some examples, based on the sensor data received from the motion sensors, the controller may determine that the passenger has exited or entered the suite or that the passenger is moving and awake or, conversely, not moving, indicating that the passenger may have drifted off to sleep. In some implementations, monitoring a status of the aircraft cabin may include monitoring an amount of illumination within the aircraft cabin, which may include a combination of light passing into the cabin from outside the aircraft through the windows and light from aircraft cabin lights.

In some implementations, if the status of the passenger and/or aircraft cabin has changed from a previous status (604) and if, in some examples, the change in status of the passenger and/or aircraft cabin is associated with a change in the current illumination characteristics of the transparent panel (606), then updated illumination characteristics for the transparent panel are determined (608), according to some implementations. For example, if a reduction in illumination of an aircraft cabin below a predetermined threshold is detected, which may occur when the sun sets or when the cabin lights are dimmed, an amount of change in the intensity of light output by the washlights of the illumination system proportional to the reduction in illumination of the aircraft cabin is determined. In addition, the updated illumination characteristics for the illumination system of the transparent panel may reflect any received inputs from the passenger and/or flight attendant.

In some implementations, if it is determined that the updated illumination characteristics form the washlights of the illumination system may not affect other passengers within the aircraft cabin (610), then the illumination system is adjusted to reflect the updated characteristics of the illumination system (612). In some implementations, the controller for the illumination system may output control signals to adjust a color, color pattern, intensity, or other characteristics of light output by illumination devices. In some examples, the controller outputs control signals to the local controller 308 of each washlight 300 (FIG. 3) of the illumination system, and the local controller 308 locally controls the output of light from the LEDs 310 of the washlight 300.

In some implementations, if it is determined that the updated characteristics may affect one or more other passengers within the aircraft cabin, then the current illumination characteristics of the illumination system for the transparent panel may be maintained (614). For example, if the transparent panel is part of a privacy panel separating two adjacent suites, and a passenger requests an increase in the amount of illumination applied to the transparent panel, the controller may output a message to a suite video monitor indicating that the request is denied because the seat of the passenger in an adjacent suite is in the lie-flat position, indicating that the adjacent passenger may be asleep, and an increase in the amount of illumination applied to the transparent panel may disturb the sleeping passenger.

Including transparent panels within the interior of an aircraft cabin can greatly reduce the workload of the cabin flight attendant for performing their tasks during TTL. For example, a task of walking around the cabin unlatching and latching the fold down flaps for TTL is eliminated and replaced with toggling an electronic switch configured to change opacity of a transparent panel utilizing one or more electronic glass technologies.

Including transparent panels within the interior of an aircraft cabin increases an amount of light transmitted throughout an aircraft cabin while still maintaining privacy for the passengers due to the graphical designs applied to the transparent panels and adjustable amounts of illumination that are directed toward the transparent panels. In addition, advantage of the implementations described above also include providing graphical images that are pleasing for passengers to look at and also having an additional means for promoting brands and/or products through graphical designs that include advertising indicia. In some implementations, transparent panels located within a field of view of a passenger may have graphical designs including advertising indicia in order to maximize an amount of exposure of the passengers to advertisements.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. An aircraft partition, comprising:
a panel or frame portion residing substantially in a first plane, the panel or frame portion being opaque and constructed of a material that does not transmit visible light;
a planar dimmable portion, the dimmable portion being substantially co-planar with the panel or frame portion, the dimmable portion configured to operate in a transparent condition and in an opaque condition, the dimmable portion further being located to permit crew line of sight through the partition system when the dimmable portion is in the transparent condition;
control circuitry communicatively coupled to the dimmable portion comprising processing circuitry, and a non-transitory computer readable medium having instructions stored thereon, wherein the instructions, when executed by the control circuitry, cause the control circuitry to receive at least one selection from a computing device related to a dimmable panel setting and translate the at least one setting into at least one control signal to switch the dimmable portion between the transparent condition and the opaque condition.

2. The aircraft partition of claim 1, further comprising a graphical design element applied to the dimmable portion.

3. The aircraft partition of claim 2, further comprising a light source disposed in the panel or frame portion.

4. The aircraft partition of claim 3, wherein the light source is configured to illuminate the graphical design element.

5. The partition of claim 2, wherein the graphical design element includes retail or branded content.

6. The aircraft partition of claim 1, wherein the control circuitry is configured to set the dimmable panel to at least two selectable opacities, said opacities being at least 70 percent.

7. The aircraft partition of claim 1, wherein the control circuitry is configured to set the panel to a transparent condition during taxi, take-off and landing.

8. The aircraft partition of claim 1, wherein the panel or frame portion at least partially separates a passenger suite from an adjacent aisle region.

9. The aircraft partition of claim 1, wherein the panel or frame portion at least partially separates a fore cabin of an aircraft from an aft cabin of an aircraft.

10. The partition of claim 1, wherein the panel or frame portion at least partially separates a passenger suite from an adjacent passenger suite.

11. The partition of claim 1, wherein the transparent portion comprises electronic glass.

12. The partition of claim 11, wherein the electronic glass material comprises an electrochromic layer.

13. An aircraft partition, comprising:
a panel or frame portion residing substantially in a first plane, the panel or frame portion being opaque and constructed of a material that does not transmit visible light;
a planar non-opaque portion, the non-opaque portion being substantially co-planar with the panel or frame portion, non-opaque portion further being located to permit crew line of sight through the partition;
a graphical design element applied to the non-opaque portion; and
a light source disposed in the panel or frame portion and configured to illuminate the graphical design element.

14. The aircraft partition of claim 13, wherein the non-opaque portion comprises a planar dimmable portion configured to operate in a transparent condition and in an opaque condition, the dimmable portion further being located to permit crew line of sight through the partition system when the dimmable portion is in the transparent condition.

15. The aircraft partition of claim 14, further comprising control circuitry communicatively coupled to the dimmable portion comprising processing circuitry, and a non-transitory computer readable medium having instructions stored thereon, wherein the instructions, when executed by the control circuitry, cause the control circuitry to receive at least one selection from a computing device related to a dimmable panel setting and translate the at least one setting into at least one control signal to switch the dimmable portion between the transparent condition and the opaque condition.

16. The aircraft partition of claim 15, wherein the control circuitry is configured to set the dimmable panel to at least two selectable opacities, said opacities being at least 70 percent.

17. The aircraft partition of claim 15, wherein the control circuitry is configured to set the panel to a transparent condition during taxi, take-off and landing.

18. The aircraft partition of claim 13, wherein the panel or frame portion at least partially separates a passenger suite from an adjacent aisle region.

19. The aircraft partition of claim 13, wherein the panel or frame portion at least partially separates a fore cabin of an aircraft from an aft cabin of an aircraft.

20. The aircraft partition of claim 13, wherein the panel or frame portion at least partially separates a passenger suite from an adjacent passenger suite.

21. The aircraft partition of claim 13, wherein the graphical design element includes retail or branded content.

22. The partition of claim 14, wherein the transparent portion comprises electronic glass.

23. The partition of claim 22, wherein the electronic glass material comprises an electrochromic layer.
